(19) United States
(12) Patent Application Publication
(10) Pub. No.: US 2023/0057696 A1
(43) Pub. Date: Feb. 23, 2023

(54) NAVIGATION SYSTEM AND NAVIGATION METHOD THAT INDICATE A CORRECT LANE

(71) Applicant: Old Cookies Co., Ltd., Taipei City (TW)

(72) Inventors: Shih-Chiun HONG, Taipei City (TW); Jih-Cherng Dennis CHEN, Taipei City (TW)

(21) Appl. No.: 17/891,896

(22) Filed: Aug. 19, 2022

(30) Foreign Application Priority Data
Aug. 23, 2021 (TW) 110131034

(51) Int. Cl. G01C 21/36; G06V 20/56; G06T 11/00; G02B 27/01

(52) U.S. Cl. CPC G01C 21/3602; G06V 20/588; G06T 11/00; G01C 21/3658; G01C 21/365; G02B 27/0101; G02B 2027/0141

(57) ABSTRACT

A navigation system adapted to be installed on a vehicle includes an output device and a processing device. The processing device executes the following steps after determining a planned route: obtaining real-time image data and performing image recognition on the image data to identify at least one lane from the image data; obtaining a real-time positioning result that indicates a current location of the navigation system; based on the planned route and the positioning result, selecting a target lane that corresponds to a moving directive presented by the planned route; and controlling the output device to visually output a route indicator that indicates the target lane.

### CROSS-REFERENCE TO RELATED APPLICATIONS

This application claims priority of Taiwanese Patent Application No. 110131034, filed on Aug. 23, 2021.

### FIELD

The disclosure relates to a navigation system, more particularly to a navigation system suitable for application to a vehicle. The disclosure further relates to a navigation method implemented by said navigation system.

### BACKGROUND

In modern society, the driver of a vehicle usually utilizes a navigation system to provide assistance when driving. However, at intersections where there are many complicated or irregular branches, the navigation system is unable to give a clear guidance to the correct path since the audio prompts from the navigation system might not match the reality very well. Moreover, when the driver is unfamiliar with the actual road conditions, the driver might still divert from the planned route given by the navigation system by taking an incorrect lane, even with the aids from the navigation system. How to avoid the aforementioned problems is an issue worth exploring.

### SUMMARY

Therefore, one object of the present disclosure is to provide a navigation system that can indicate the correct lane to the driver and alleviate at least one of the drawbacks of the prior art.

According to one aspect of this disclosure, there is provided a navigation system that is adapted to be installed on a vehicle and that includes an output device and a processing device. The processing device is electrically connected to the output device, and executes the following steps after determining a planned route:

obtaining real-time image data and continuously performing image recognition on the image data to identify at least one lane that is presented by the image data;

obtaining a real-time positioning result that indicates a current location of the navigation system;

based on the planned route and the positioning result, selecting a target lane from among the at least one lane presented by the image data, wherein the target lane corresponds to a moving directive presented by the planned route; and

controlling the output device to visually output a route indicator that indicates the target lane.

Another object of this disclosure is to provide a navigation method implemented by said navigation system.

According to another aspect of this disclosure, there is provided a navigation method to be implemented by a navigation system installed on a vehicle. The navigation method includes the following steps:

determining a planned route;

obtaining real-time image data and continuously performing image recognition on the image data to identify at least one lane that is presented by the image data;

obtaining a real-time positioning result that indicates a current position of the navigation system;

based on the planned route and the positioning result, selecting a target lane from among the at least one lane presented by the image data, the target lane corresponding to a moving directive presented by the planned route; and

visually outputting a route indicator that indicates the target lane.

### BRIEF DESCRIPTION OF THE DRAWINGS

Other features and effects related to the disclosure will become apparent in the following detailed description of the embodiment(s) with reference to the accompanying drawings, of which:

FIG. 1 is a block diagram of an embodiment of a navigation system of the present disclosure when applied to a vehicle; and

FIG. 2 is a flow chart for exemplarily illustrating how the embodiment implements a navigation method.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics. Where not specifically defined, the terms “electrical connection” in the disclosure refers generally to a “wired electrical connection” between a plurality of electronic equipment/devices/components connected to each other by conductive materials, or a “wireless electrical connection” for the transmission of one-way/two-way wireless signals by means of wireless communication technologies. Furthermore, the term “electrical connection” also refers to a “direct electrical connection” between multiple electronic equipment/devices/components directly connected to each other, or an “indirect electrical connection” between multiple electronic equipment/devices/components indirectly connected to each other via other electronic equipment/devices/components.

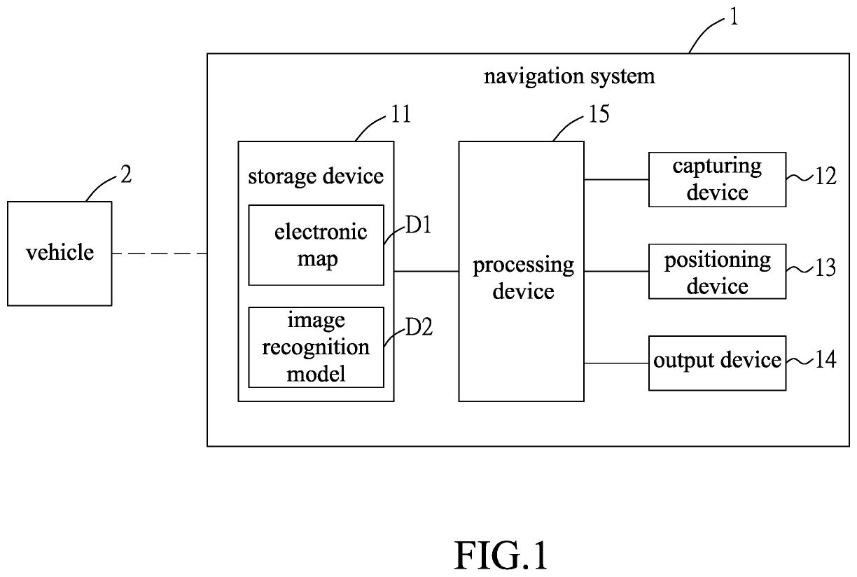

Referring to FIG. 1, an embodiment of a navigation system 1 of the present disclosure is adapted to be installed on a vehicle 2, and includes a storage device 11, a capturing device 12, a positioning device 13, an output device 14 and a processing device 15. The processing device 15 is electrically connected to the storage device 11, the capturing device 12, the positioning device 13 and the output device 14.

In this embodiment, the navigation system 1 can be manufactured and sold independently, and then added to the vehicle 2 after the vehicle 2 leaves the factory. However, in other embodiments, the navigation system 1 may be built-in with the vehicle 2 before the vehicle 2 leaves the factory. Therefore, the actual implementation of the navigation system 1 is not limited to this embodiment.

The storage device 11 may, in this embodiment, be embodied as flash memory for storing digital data. However, in other embodiments, the storage device 11 may also be implemented as a traditional hard disk, a solid state drive, random access memory (RAM), read only memory (ROM), programmable ROM (PROM), or other types of computer readable storage media, or a combination of multiple different types of computer readable storage media, and is not limited to this embodiment.

In this embodiment, the storage device 11 stores electronic map data D1 and an image recognition model D2.

To elaborate, in this embodiment, besides the interconnection relationships among a plurality of roads, the electronic map data Dl further includes the number of lanes in each road or road segment, and the lane type of each lane (such as forward only lane, left turn only lane, right turn only lane, on-ramp lane, etc.), but is not limited thereto.

In this embodiment, the image recognition model D2 is a trained neural network that can be loaded and operated by the processing device 15. The image recognition model D2 is obtained by machine learning techniques utilizing, for example, pictures or photos of lanes and a plurality of road surface markings as training data, but is not limited thereto. The road surface markings are also known as pavement markings, and examples thereof include lane-delineating markings that are used to define lanes or separate adjacent lanes (which may be lanes of traffic going in the same or different directions) and that are generally in the form of lines (e.g., solid white lines, broken white lines, solid yellow lines, broken yellow lines, double solid white lines, double solid yellow lines, one-solid-one-broken white lines, etc.) and lane-direction markings that are used to indicate the directions of traffic of the lanes and that may be arrow-shaped or composed of characters used to specify the directions of traffic. By running the image recognition model D2, the processing device 15 is capable of performing image recognition on an image to recognize the aforementioned various road surface markings from the image. The processing device 15 further recognizes one or more lanes in the image based on the recognized road surface markings and consequently determines the number of lanes and the lane type of each lane. It should be noted that image recognition techniques and machine learning techniques are well known in the art, and the implementation of how the image recognition model D2 achieves lane recognition is not the focus of this disclosure and therefore is not described in detail herein.

In this embodiment, the capturing device 12 is implemented as an image capturing lens module that includes a lens set and an image sensor module. The capturing device 12 is adapted to be installed facing forward from the perspective of the vehicle 2 to perform video recording and generate real-time image data, but is not limited thereto. It is worth mentioning that although the capturing device 12 is a part of the navigation system 1 in this embodiment, in other embodiments, the capturing device 12 may also be an external device not belonging to the navigation system 1.

The positioning device 13 in this embodiment is implemented as a satellite positioning module based on satellite positioning technology. The positioning device 13 is capable of receiving satellite signals so as to determine the current position of the positioning device 13 in real time. Specifically, in this embodiment, the satellite signals may be from satellites of Global Positioning System (abbreviated as GPS). In other words, the positioning device 13 in this embodiment is a GPS positioning module. However, in other embodiments, the satellite signals as described may also be from other satellite navigation systems that provide a real-time positioning function, referred to as Global Navigation Satellite Systems (abbreviated as GNSS's), such as BeiDou Navigation Satellite System (BDS), Galileo and GLONASS, etc. Therefore, the actual implementation of the positioning device 13 is not limited to this embodiment.

The output device 14 in this embodiment is implemented to be a projector module having a lens for projecting images. The lens is installed to face the windshield (i.e., front window) of the vehicle 2, so that the output device 14 can project information onto the windshield of the vehicle 2. However, in other embodiments, the output device 14 may be implemented as a display screen. Therefore, the actual embodiment of the output device 14 is not limited to this embodiment.

The processing device 15 in this embodiment is implemented as a central processing unit (CPU). However, in other embodiments, the processing device 15 may be implemented as a plurality of CPUs electrically connected to one another, a control circuit board including a CPU, a digital signal processor (DSP), a field-programmable gate array (FPGA), an application specific integrated circuit (ASIC), and/or a radio-frequency integrated circuit (RFIC), etc. The CPU mentioned herein may be implemented by a single core processor, a multi-core processor, a dual-core mobile processor, a microprocessor, a microcontroller, or the like. Thus, the implementation of the processing device 15 is not limited to this embodiment.

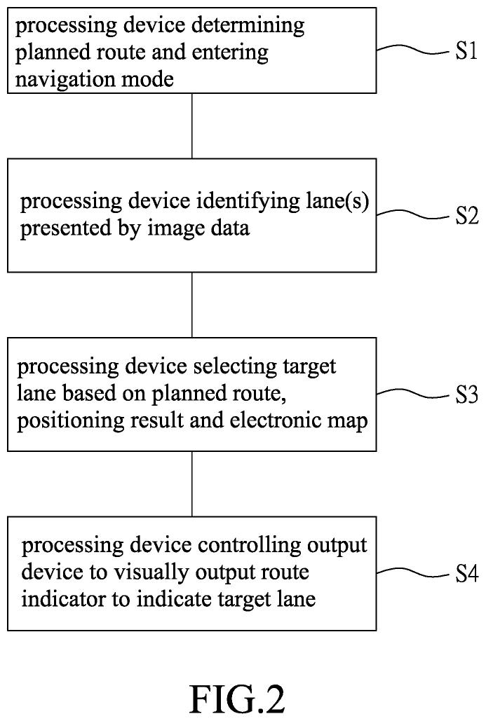

Referring to FIG. 1 and FIG. 2 simultaneously, how the navigation system 1 of the present embodiment implements a navigation method will be exemplarily described in detail below.

First, in step S1, the processing device 15 determines a planned route based on the electronic map D1 and an input (such as a destination) inputted by a user (e.g., the driver of the vehicle 2) operating the navigation system 1, then enters a navigation mode based on the planned route. The planned route is used to guide a driver to drive the vehicle 2 from a current location to, for example, the destination.

In this embodiment, once the processing device 15 has entered the navigation mode, the processing device 15 controls the capturing device 12 to start recording videos continuously so as to obtain real-time image data from the capturing device 12. By means of the processing device 15 running the image recognition model D2, image recognition is continuously performed on the image data. To elaborate, in this embodiment, the image data is a real-time image generated from video recording conducted by the capturing device 12, and the image recognition performed by the processing device 15 on the image data includes at least recognizing a plurality of road surface markings (such as lane-delineating markings and/or lane-direction markings) presented by the image data, but is not limited to such.

In addition, once the processing device 15 has entered the navigation mode, the processing device 15 further controls the positioning device 13 to start positioning continuously, and obtains a real-time positioning result from the positioning device 13, which indicates a real-time current position of the navigation system 1 (equivalent to the current position of the vehicle 2).

After the processing device 15 has entered the navigation mode, the flow proceeds to step S2.

In step S2, while operating under the navigation mode, the processing device 15 identifies one or more lanes presented by the image data based on the road surface markings thus recognized in step S1, determines the number of lane(s) there is/are, and determines the lane type of each lane thus identified. For the purpose of illustration, it is assumed that the processing device 15 identifies multiple lanes in step S2, but this disclosure is not limited thereto.

After the processing device 15 identifies the lanes from the image data, the flow proceeds to step S3.

In step S3, under the condition that the processing device 15 has identified multiple lanes from the image data, the processing device 15 selects a target lane from among the lanes based on the planned route, the positioning result and the electronic map D1. The target lane corresponds to a moving directive presented by the planned route (i.e., how and where the planned route intends to lead the vehicle 2 to travel).

As an example, assuming that the processing device 15 has identified three lanes, namely a left turn only lane, a forward only lane and a right turn only lane, and further assuming that, based on the current position of the navigation system 1 (equivalent to the current position of the vehicle 2) and the electronic map D1, the processing device 15 determines that the vehicle 2 should take the right turn only lane so that movement or travel of the vehicle 2 can match the planned route, the processing device 15 will select the right turn only lane from among all three identified lanes to be the target lane. As another example, assuming that the processing device 15 has identified three lanes: a forward only lane; a right turn only lane; and a lane that leads toward the right-forward direction instead of straight ahead or a right-turn and that is located between the forward only lane and the right turn only lane, and further assuming that, based on the current position of the navigation system 1 and the electronic map D1, the processing device 15 determines that the vehicle 2 should take the lane that leads toward the right-forward direction so that the movement/travel of the vehicle 2 can match the planned route, the processing device 15 will select this lane from among all three identified lanes to be the target lane.

After the processing device 15 has selected the target lane from among all the lanes, the flow proceeds to step S4.

In step S4, the processing device 15 controls the output device 14 to visually output a route indicator to indicate the target lane. In this embodiment, the processing device 15 controls the output device 14 to output the route indicator by controlling the output device 14 to project the route indicator onto the windshield of the vehicle 2.

In this embodiment, after the processing device 15 has selected the target lane, the processing device 15 will designate those of the road surface markings that are associated with the target lane as a plurality of key road surface markings. As an example, assuming that the processing device 15 has selected the right turn only lane as the target lane, the processing device 15 will take the two lane-delineating markings that define the right turn only lane, and a lane-direction marking that is located between the two lane-delineating markings (i.e., within the right turn only lane) and that is in the form of a right-turning arrow as three key road surface markings, respectively. In a different application but using the same example, it is also possible for the key road surface markings to include only the two lane-delineating markings, but not the lane-direction marking.

In another example, the target lane may be a regular lane (not a lane with a dedicated direction of traffic), and the key road surface markings may include only the two lane-delineating markings that define the target lane (the two lane-delineating markings that mark the left and right borders of the target lane).

Further, in this embodiment, the route indicator includes a plurality of indicator graphics that correspond to the key road surface markings, respectively. In an example, each indicator graphic may be presented translucently on the windshield of the vehicle 2, and the shape of each indicator graphic is, for example, compliant with the shape of the corresponding key road surface marking as seen from the driver's viewing position. In addition, the processing device 15 controls the output device 14 to output the route indicator by, for example, controlling the output device 14 to project the indicator graphics respectively onto a plurality of key projection locations on the windshield, wherein the key projection location of each indicator graphic corresponds to the corresponding key road surface marking to which the indicator graphic corresponds, and relates to the relative positional relationship among the corresponding key road surface marking, the driver's viewing position and the windshield.

To elaborate, the driver's viewing position represents the eye level of the driver when the driver is driving the vehicle 2, i.e., a point of view of the driver. As an example, for a key road surface marking that is a lane-direction marking in the form of a right-turning arrow, the key projection location for projection of the corresponding indicator graphic translucently onto the windshield should be located at a location where the lane-direction marking forms a perspective projection on the windshield from the perspective of the driver's viewing position with the windshield serving as the projection surface. In addition, the shape of the indicator graphic that corresponds to the lane-direction marking, as projected on the windshield, matches the shape of the lane-direction marking as seen from the driver's viewing position. It should be noted that the shapes and the key projection locations of the other two indicator graphics projected on the windshield should correspond to their corresponding key road surface markings, just like how the shape and key projection location of the indicator graphic that corresponds to the lane-direction marking correspond to the lane-direction marking, so relevant details are not repeated here.

Therefore, when the navigation system 1 projects the indicator graphics respectively onto their corresponding key projection locations on the windshield, their shapes and locations will correspond to the corresponding key road surface markings as seen from the driver's viewing position. In other words, the indicator graphics projected onto the windshield can function like superimposed augmented reality for the driver, and present the target lane for the driver's reference clearly.

It should be noted that, in this embodiment, each key projection location is calculated in real time by the processing device 15 based on a perspective coordinate parameter that indicates the driver's viewing position and further based on the position of the corresponding key road surface marking in the real-time image data. The perspective coordinate parameter can be, for example, preset by the driver during a projection location calibration procedure, but is not limited thereto. The perspective coordinate parameter may be a set of coordinates in a three-dimensional coordinate system in one embodiment. In one embodiment, the projection location calibration procedure calculates the perspective coordinate parameter based on the driver's body shape (e.g., height), the driver's eye level, a front-rear position of the driver seat in the vehicle 2 (for example, with respect to the windshield), etc.

The above is an exemplified illustration of how the navigation system 1 of the present embodiment implements the navigation method.

It should be understood that steps S1 to S4 and the flow chart of FIG. 2 of this embodiment are merely to illustrate one way of implementing the navigation method, and implementations with steps S1 to S4 being merged, split or adjusted in terms of execution order still belong to the present disclosure, as long as they can achieve the same effect as the described embodiment. Therefore, steps S1 to S4 and the flowchart of FIG. 2 in this embodiment are not intended to limit the scope of the present disclosure.

In summary, the navigation system 1 can, from the image data, identify a target lane that corresponds to the moving directive presented by the planned route, and output the route indicator to indicate the target lane. By projecting the route indicator onto the windshield of the vehicle 2, the navigation system 1 can clearly indicate the target lane to the driver, thereby effectively preventing the driver from driving on an incorrect lane and diverting from the planned route. As such, the object of the present disclosure can be achieved.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

What is claimed is:

1. A navigation system adapted to be installed on a vehicle, the navigation system comprising:
an output device; and
a processing device electrically connected to the output device, wherein the processing device executes the following steps after determining a planned route:
obtaining real-time image data and continuously performing image recognition on the image data to identify at least one lane that is presented by the image data;
obtaining a real-time positioning result that indicates a current location of the navigation system;
based on the planned route and the positioning result, selecting a target lane from among the at least one lane presented by the image data, wherein the target lane corresponds to a moving directive presented by the planned route; and
controlling the output device to visually output a route indicator that indicates the target lane.

2. The navigation system as claimed in claim wherein the processing device performs the image recognition by identifying a plurality of road surface markings presented by the image data, and further identifying the at least one lane based on the road surface markings thus identified.

3. The navigation system as claimed in claim 2, the vehicle including a windshield, wherein:
the processing device makes those of the plurality of road surface markings that are associated with the target lane serve as key road surface markings, and the route indicator includes a plurality of indicator graphics that respectively correspond to the key road surface markings; and
the processing device controls the output device to output the route indicator by controlling the output device to project the indicator graphics respectively onto a plurality of key projection locations on the windshield, each of the key projection locations corresponding to the respective one of the key road surface markings and relating to a relative positional relationship between a viewing position of a driver of the vehicle and the windshield.

4. The navigation system as claimed in claim 3, wherein the key road surface markings at least include a lane-delineating marking, and a shape of one of the indicator graphics that corresponds to the lane-delineating marking matches a shape of the lane-delineating marking as seen from the viewing position of the driver.

5. The navigation system as claimed in claim 3, wherein the key road surface markings at least include a lane-direction marking, and a shape of one of the indicator graphics that corresponds to the lane-direction marking matches a shape of the lane-direction marking as seen from the viewing position of the driver.

6. The navigation system as claimed in claim 1, the vehicle including a windshield, wherein the processing device controls the output device to output the route indicator by controlling the output device to project the route indicator onto the windshield.

7. A navigation method to be implemented by a navigation system installed on a vehicle, the navigation method comprising steps of:
determining a planned route;
obtaining real-time image data and continuously performing image recognition on the image data to identify at least one lane that is presented by the image data;
obtaining a real-time positioning result that indicates a current position of the navigation system;
based on the planned route and the positioning result, selecting a target lane from among the at least one lane presented by the image data, the target lane corresponding to a moving directive presented by the planned route; and
visually outputting a route indicator that indicates the target lane.

8. The navigation method as claimed in claim 7, wherein the step of continuously performing image recognition includes identifying a plurality of road surface markings presented by the image data, and further identifying the at least one lane based on the road surface markings thus identified.

9. The navigation method as claimed in claim S the vehicle including a windshield, wherein the step of visually outputting a route indicator includes:
making those of the plurality of road surface markings that are associated with the target lane respectively serve as a plurality of key road surface markings, the route indicator including a plurality of indicator graphics that respectively correspond to the key road surface markings; and
projecting the indicator graphics respectively onto a plurality of key projection locations on the windshield, each of the key projection locations corresponding to the respective one of the key road surface markings and relating to a relative positional relationship between a viewing position of a driver of the vehicle and the windshield.

10. The navigation method as claimed in claim 9, wherein the key road surface markings at least include a lane-delineating marking, and a shape of one of the indicator graphics that corresponds to the lane-delineating marking matches a shape of the lane-delineating marking as seen from the viewing position of the driver.

11. The navigation method as claimed in claim 9, wherein the key road surface markings at least include a lane-direction marking, and a shape of one of the indicator graphics that corresponds to the lane-direction marking matches a shape of the lane-direction marking as seen from the viewing position of the driver.

12. The navigation method as claimed in claim 7, the vehicle including a windshield, wherein the step of visually outputting a route indicator includes projecting the route indicator onto the windshield.
